(19) United States
(12) Patent Application Publication
(10) Pub. No.: US 2025/0249658 A1
(43) Pub. Date: Aug. 7, 2025

(54) MATERIALS, SYSTEMS, AND METHODS FOR FOIL ENCAPSULATION OF AEROGELS AND AEROGEL COMPOSITES

(71) Applicant: Aspen Aerogels, Inc., Northborough, MA (US)

(72) Inventor: Younggyu Nam, Medford, MA (US)

(21) Appl. No.: 18/695,338

(22) PCT Filed: Jan. 27, 2023
(86) PCT No.: PCT/IB2023/050741

§ 371 Date: Mar. 25, 2024

Related U.S. Application Data
(60) Provisional application No. 63/304,258, filed on Jan. 28, 2022.
(60) Provisional application No. 63/313,063, filed on Feb. 23, 2022.

(51) Int. Cl. B32B 15/085; B32B 1/00; B32B 7/027; B32B 7/12; B32B 27/08; B32B 27/32

(52) U.S. Cl. CPC B32B 15/085; B32B 1/00; B32B 7/027; B32B 7/12; B32B 27/08; B32B 27/32; B32B 2250/04; B32B 2266/126; B32B 2307/7376

(57) ABSTRACT

The present disclosure relates to materials and systems to manage thermal runaway issues in energy storage systems. Exemplary embodiments include an insulation layer that is encapsulated to form an insulation barrier. The encapsulation layer is made from a laminate film that comprises a malleable layer sandwiched between an outer polymer layer and an inner polymer layer.

### CROSS-REFERENCE TO RELATED APPLICATIONS

This application claims the benefit of and priority to U.S. Provisional Patent Application No. 63/304,258 filed on Jan. 28, 2022 and entitled “Materials, Systems, and Methods for Foil Encapsulation of Aerogels and Aerogel Composites” and U.S. Provisional Patent Application No. 63/313,063 filed on Feb. 23, 2022 and entitled “Materials, Systems, and Methods for Foil Encapsulation of Aerogels and Aerogel Composites”. The contents of both provisional applications are incorporated herein by reference in their entirety.

### FIELD OF THE TECHNOLOGY

The present disclosure relates generally to materials, systems, and methods for encapsulating materials. In particular, the present disclosure relates to materials, systems and methods for encapsulation of thermal barriers that are used between battery cells or battery modules in energy storage systems. The present disclosure further relates to the encapsulation of aerogel thermal barriers. The present disclosure further relates to a battery module or battery pack with one or more battery cells that includes the encapsulated thermal barrier materials, as well as systems including those battery modules or battery packs.

### BACKGROUND

Rechargeable batteries such as lithium-ion batteries have found wide application in the power-driven and energy storage systems. Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, or operated at or exposed to high temperature and high pressure. As a consequence, narrow operational temperature ranges and charge/discharge rates are limitations on the use of LIBs, as LIBs may fail through a rapid self-heating or thermal runaway event when subjected to conditions outside of their design window.

Thermal runaway may occur when the internal reaction rate increases to the point that more heat is being generated than can be withdrawn, leading to a further increase in both reaction rate and heat generation. During thermal runaway, high temperatures trigger a chain of exothermic reactions in a battery, causing the battery's temperature to increase rapidly. In many cases, when thermal runaway occurs in one battery cell, the generated heat quickly heats up the cells in close proximity to the cell experiencing thermal runaway. Each cell that is added to a thermal runaway reaction contains additional energy to continue the reactions, causing thermal runaway propagation within the battery pack, eventually leading to a catastrophe with fire or explosion. Prompt heat dissipation and effective block of heat transfer paths can be effective countermeasures to reduce the hazard caused by thermal runaway propagation.

Based on the understanding of the mechanisms leading to battery thermal runaway, many approaches are being studied, with the aim of reducing safety hazards through the rational design of battery components. To prevent such cascading thermal runaway events from occurring, LIBs are typically designed to either keep the energy stored sufficiently low or employ enough insulation material between cells within the battery module, or pack to insulate them from thermal events that may occur in an adjacent cell, or a combination thereof. The former severely limits the amount of energy that could potentially be stored in such a device. The latter limits how close cells can be placed and thereby limits the effective energy density.

There are currently a number of different methodologies employed to maximize energy density while guarding against cascading thermal runaway. One approach is to incorporate a sufficient amount of insulation between cells or clusters of cells. This approach is generally thought to be desired from a safety vantage; however, in this approach the ability of the insulating material to contain the heat, combined with the volume of insulation required dictate the upper limits of the energy density that can be achieved.

Another approach is through the use of phase change materials. These materials undergo an endothermic phase change upon reaching a certain elevated temperature. The endothermic phase change absorbs a portion of the heat being generated and thereby cools the localized region. Typically, for electrical storage devices these phase change materials rely on hydrocarbon materials such as waxes and fatty acids for example. These systems are effective at cooling but are themselves combustible and therefore are not beneficial in preventing thermal runaway once ignition within the storage device does occur.

Incorporation of intumescent materials is another strategy for preventing cascading thermal runaway. These materials expand above a specified temperature producing a char that is designed to be lightweight and provide thermal insulation when needed. These materials can be effective in providing insulating benefits, but the expansion of the material must be accounted for in the design of the storage device.

Aerogel materials have also been used as thermal barrier materials. Aerogel thermal barriers offer numerous advantages over other thermal barrier materials. Some of these benefits include favorable resistance to heat propagation and fire propagation while minimizing thickness and weight of materials used. Aerogel thermal barriers also have favorable properties for compressibility, compressional resilience, and compliance. Some aerogel based thermal barriers, due to their light weight and low stiffness, can be difficult to install between battery cells, particularly in a mass production setting. Furthermore, aerogel thermal barriers tend to produce particulate matter (dust) that can be detrimental to the electrical storage systems, creating manufacturing problems.

With many different materials available, each having many different properties, both favorable and otherwise, it would be advantageous to encapsulate a thermal barrier material to provide additional protection to both the battery cells and the thermal barrier, while also simplifying the manufacturing process.

### SUMMARY

It is an object of the present disclosure to obviate or mitigate at least one disadvantage of previous methods and materials mentioned above. The support members provided herein are designed to improve encapsulation and handling of thermal barriers used in battery modules or battery packs.

In an aspect of the present disclosure, an insulation barrier for use in an electrical energy storage system comprises: at least one insulation layer and an encapsulation layer at least partially surrounding the insulation layer. The encapsulation layer comprises a laminate film comprising an outer polymer layer, a malleable layer comprising a malleable material, and an inner polymer layer. The inner polymer layer is in contact with the insulation layer and the malleable layer is disposed between the outer polymer layer and the inner polymer layer

The outer polymer layer comprises a polymer that is resistant to dielectric heat transfer fluids in the electrical energy storage system. For example, the outer polymer layer comprises a polymer that is resistant to a heat transfer fluid selected from the group consisting of hydrocarbon fluids, ester fluids, silicone fluids, fluoroether fluids, and combinations thereof. In one aspect of the present disclosure, the outer polymer layer is made from a polymer selected from the group consisting of polyoxymethylene, acrylonitrile butadiene styrene, polyamide-imide, polyamide, polycarbonate, polyester, polyetherimide, polystyrene, polysulfone, polyimide, and terephthalate.

The inner polymer layer comprises a polymer that can be heat welded to itself. For example, the inner polymer layer comprises a polyolefin polymer. In some aspects, the inner polymer is composed of a polymer that is different from the polymer in the outer polymer layer.

The malleable layer comprises, in some aspects a metal foil. In some aspects, the malleable layer comprises a malleable polymer.

In an aspect of the disclosure, the encapsulation layer further comprises an adhesive disposed between the outer polymer layer and the malleable layer and/or the inner polymer layer and the malleable layer.

In an aspect of the disclosure, the outer polymer layer has a thickness of about 10 μm to about 100 μm. In an aspect of the disclosure, the malleable layer has a thickness of about 10 μm to about 100 μm. In an aspect of the disclosure, the inner polymer layer has a thickness of about 10 μm to about 100 μm. In an aspect of the disclosure, the encapsulation layer has a total thickness of between about 30 μm to about 300 μm.

In an aspect of the disclosure, the insulation layer has a thermal conductivity through a thickness dimension of said insulation layer of less than about 50 mW/m-K at 25° C. and less than about 60 mW/m-K at 600° C. In an aspect of the disclosure, the insulation layer comprises an aerogel.

In an aspect of the disclosure, the encapsulation layer completely surrounds the insulation layer. The encapsulation layer, in an aspect of the disclosure, is composed of two laminate films heat welded together. In an aspect of the disclosure, the encapsulation layer surrounds the insulation layer. The encapsulation layer is heat welded to itself to form an enclosure at least partially surrounding the insulation layer.

In an aspect of the disclosure, a method of encapsulating an insulation layer for use between battery cells in an electrical energy storage system, the method comprises: surrounding at least a portion of the insulation layer with a laminate film comprising an outer polymer layer, a malleable layer comprising a malleable material, and an inner polymer layer, wherein the inner polymer layer is in contact with the insulation layer and wherein the malleable layer is disposed between the outer polymer layer and the inner polymer layer; and heat welding the laminate film to form an encapsulation layer, wherein the encapsulation layer at least partially surrounds the insulation layer.

In an aspect of the disclosure, a method of encapsulating an insulation layer comprises covering at least a portion of the insulation layer with a first laminate film; covering at least a portion of the insulation layer with a second laminate film; and heat welding a portion of the first laminate film to the second laminate film to form the encapsulation layer.

In an aspect of the disclosure, in a method of encapsulating an insulation layer, a first indentation is formed in the first laminate film, the first indentation complementary in shape and size to the insulation layer; a second indentation is formed in the second laminate film, the second indentation complementary in shape and size to the insulation layer. Forming the encapsulation layer comprises: placing the insulation layer in the first indentation of the first laminate film; placing the second laminate film on the first laminate film with the second indentation substantially aligned with the first indentation; and heat welding a portion of the first laminate film to a portion of the second laminate film.

In an aspect of the disclosure, in a method of encapsulating an insulation layer, a first indentation is formed in the first laminate film, the first indentation complementary in shape and size to the insulation layer. A second indentation is formed in the second laminate film, the second indentation complementary in shape and size to the first indentation. Forming the encapsulation layer comprises: placing the insulation layer in the first indentation of the first laminate film; placing the second laminate film on the first laminate film with the second indentation substantially aligned with the first indentation such that a portion of the second indention is disposed inside the first indentation; and heat welding a portion of the first laminate film to a portion of the second laminate film.

In an aspect of the disclosure, in a method of encapsulating an insulation layer a first indentation is formed in the first laminate film, the first indentation complementary in shape and size to the insulation layer. A second indentation is formed in the second laminate film, the second indentation complementary in shape and size to the first indentation. Forming the encapsulation layer comprises: placing the insulation layer in the first indentation of the first laminate film; placing the second laminate film on the first laminate film with the second indentation substantially aligned with the first indentation such that a portion of the second indention is disposed inside the first indentation; and heat welding a portion of the first laminate film to a portion of the second laminate film.

In an aspect of the disclosure, in a method of encapsulating an insulation layer a first indentation is formed in the first laminate film, the first indentation complementary in shape and size to the insulation layer. A second indentation is formed in the laminate film, the second indentation complementary in shape and size to the insulation layer. Forming the encapsulation layer, at this point, comprises: placing the insulation layer in the first indentation of the laminate film; folding the laminate film such that the second indentation of the laminate film is substantially aligned with the first indentation; and heat welding a portion of the laminate film to itself.

In an aspect of the disclosure, extended the heat welded portions of the laminate film are folded against one or more sides of the insulation layer.

In another aspect of the present disclosure, a battery module comprises a plurality of battery cells and one or more insulation barriers, as described herein, disposed between adjacent battery cells.

In another aspect, provided herein is a device or vehicle including the battery module or pack according to any one of the above aspects. In some embodiments, said device is a laptop computer, PDA, mobile phone, tag scanner, audio device, video device, display panel, video camera, digital camera, desktop computers military portable computers military phones laser range finders digital communication device, intelligence gathering sensor. electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. In some embodiments, the vehicle is an electric vehicle.

The insulation barrier described herein can provide one or more advantages over existing thermal runaway mitigation strategies. The insulation barrier described herein can minimize or eliminate cell thermal runaway propagation without significantly impacting the energy density of the battery module or pack and assembly cost. The insulation barrier of the present disclosure can provide favorable properties for compressibility, compressional resilience, and compliance to accommodate swelling of the cells that continues during the life of the cell while possessing favorable thermal properties under normal operation conditions as well as under thermal runaway conditions. The insulation barriers described herein are durable and easy to handle, have favorable resistance to heat propagation and fire propagation while minimizing thickness and weight of materials used, and also have favorable properties for compressibility, compressional resilience, and compliance.

### BRIEF DESCRIPTION OF THE DRAWINGS

Having thus described the disclosure in general terms, reference will now be made to the accompanying drawings, which are not necessarily drawn to scale, and wherein: FIG. 1A is a cross sectional view of an insulation layer encapsulated by a laminate film;

FIG. 1B is a side view of a laminate film;

FIG. 1C is a side view of a laminate film having two outer polymer layers;

FIG. 2A is a schematic diagram of the process of forming an encapsulation layer around an insulation layer using two sheets of a laminate film;

FIG. 2B depicts a schematic diagram of an insulation layer encapsulated by an encapsulation layer formed by the process depicted in FIG. 2A;

FIG. 2C depicts a schematic diagram of an alternate process of forming an encapsulation layer around an insulation layer using a single sheet of laminate film;

FIG. 3A depicts a schematic diagram of the process of forming an encapsulation layer around an insulation layer using two sheets of a laminate film, where both sheets have indentations to receive the insulation layer;

FIG. 3B depicts a top view of an insulation layer encapsulated by an encapsulation layer formed by the process depicted in FIG. 3A;

FIG. 3C depicts a schematic diagram of an alternate process of forming an encapsulation layer around an insulation layer using a single sheet of laminate film having two indentations;

FIG. 4A depicts a schematic diagram of an alternate process of forming an encapsulation layer around an insulation layer using two sheets of indented laminate film;

FIG. 4B depicts a top view of an insulation layer encapsulated by an encapsulation layer formed by the process depicted in FIG. 4A;

FIG. 4C depicts a schematic diagram of an alternate process of forming an encapsulation layer around an insulation layer using a single sheet of laminate film having two indentions;

FIG. 5A depicts a schematic diagram of an alternate process of forming an encapsulation layer around an insulation layer using two sheets of laminate film, one sheet is indented while the other sheet is not;

FIG. 5B depicts a top view of an insulation layer encapsulated by an encapsulation layer formed by the process depicted in FIG. 5A;

FIG. 5C depicts a schematic diagram of an alternate process of forming an encapsulation layer around an insulation layer using a single sheet of laminate film having a single indention in one section, with the no indentations in the other section;

FIG. 6A depicts a schematic diagram of a method of folding the encapsulation layer;

FIG. 6B depicts a schematic diagram of a method of folding an encapsulation with cutouts at the corners;

FIG. 6C depicts a schematic diagram of a method of double-folding the encapsulation layer edges;

FIG. 7 depicts a schematic diagram of an indentation formed in a laminate film;

FIG. 8A depicts a flow chart of an assembly process for encapsulating an insulation barrier with a single laminate film;

FIG. 8B depicts a flow chart of an assembly process for encapsulating an insulation barrier with two laminate films;

FIG. 9 depicts a schematic diagram of a battery module having insulation barriers between battery cells;

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

In the following detailed description of the preferred embodiments, reference is made to the accompanying drawings, which form a part thereof, and within which are shown by way of illustration specific embodiments by which the disclosure may be practiced. It is to be understood that other embodiments may be utilized and structural changes may be made without departing from the scope of the disclosure.

The present disclosure is directed to an insulation barrier and systems including insulation barriers to manage thermal runaway issues in energy storage systems. Exemplary embodiments include an insulation barrier comprising at least one insulation layer and an encapsulation layer at least partially surrounding the insulation layer.

An insulation layer may include any kind of insulation layer commonly used to separate battery cells or battery modules. Exemplary insulation layers include, but are not limited to, polymer based thermal barriers (e.g., polypropylene, polyester, polyimide, and aromatic polyamide (aramid)), phase change materials, intumescent materials, aerogel materials, mineral based barrier (e.g., mica), and inorganic thermal barriers (e.g., fiberglass containing barriers).

In a preferred embodiment, the insulation layer comprises an aerogel material. A description of an aerogel insulation layer is described in U.S. Patent Application Publication No. 2021/0167438 and U.S. Provisional Patent Application No. 63/218,205, both of which are incorporated herein by reference.

The insulation layer can have a thermal conductivity through a thickness dimension of said insulation layer about 50 mW/mK or less, about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values at 25° C. under a load of up to about 5 MPa.

Insulation layers can have a number of different physical properties that make it difficult to incorporate the insulation layers into a battery module or battery pack. For example, some insulation layers have very low flexural modulus (e.g., less than 10 MPa), making the materials difficult to handle and position between battery cells. Additionally, a low flexural modulus material can be difficult to manipulate, particularly if using an automated encapsulation process. Some insulation layers tend to produce particulate matter (dust) that can be detrimental to the electrical storage systems, creating manufacturing problems.

The present disclosure helps mitigate these problems by using an encapsulation layer that comprises a laminate film. The encapsulation layer surrounds at least a portion of the insulation layer. The laminate film, in one embodiment, comprises an outer polymer layer, a malleable layer comprising a malleable material, and an inner polymer layer. The inner polymer layer is in contact with the insulation layer. The malleable layer is disposed between the outer polymer layer and the inner polymer layer. The inner and outer polymer layers serve as a barrier to prevent damage to the insulation layer from the ambient atmosphere and fluids present in the energy storage system. The malleable layer also provides protection to the insulation layer, however, the malleable layer also provides additional support to the insulation layer as a rigid, but malleable support for the insulation layer.

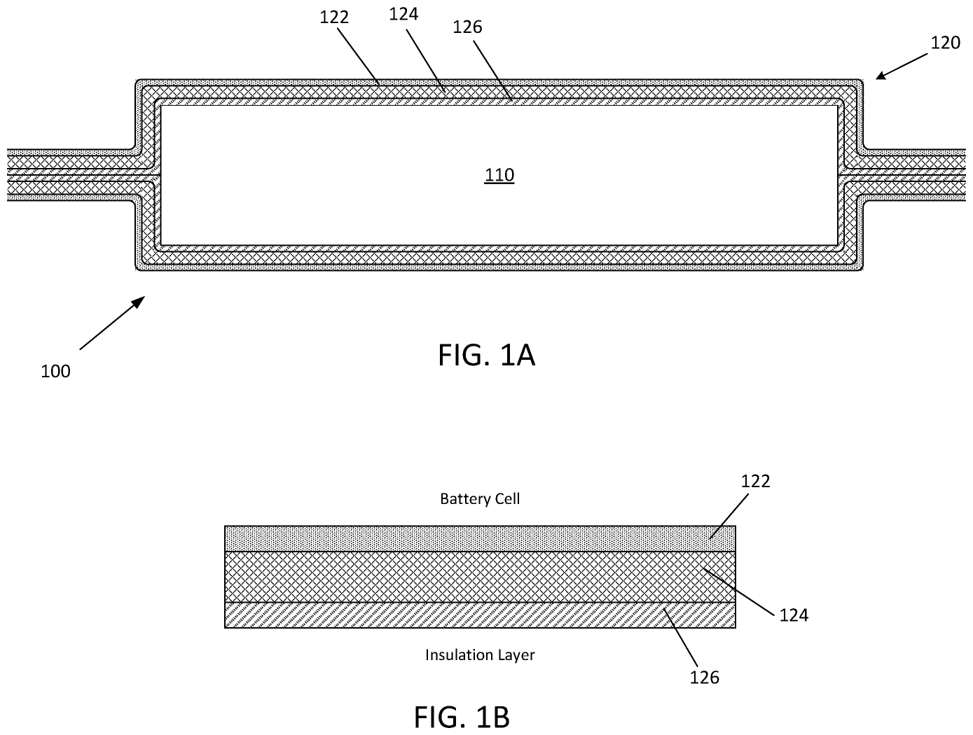

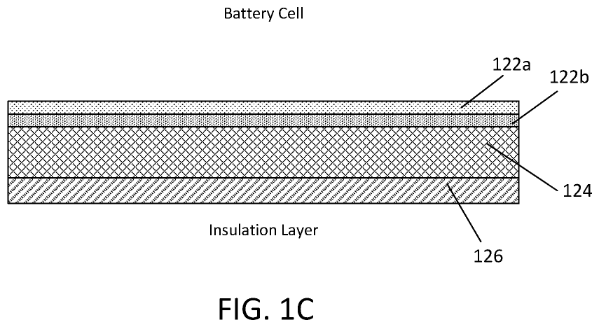

An embodiment of an insulation barrier comprising an insulation layer encapsulated by an encapsulation layer is depicted in FIG. 1A. Insulation barrier 100 includes an insulation layer 110. Insulation layer 110 is surrounded by encapsulation layer 120. In an embodiment, encapsulation layer, is a laminate film comprising an outer polymer layer 122, a malleable layer 124 and an inner polymer layer 126. An enlarged, side view, of the laminate film is shown in FIG. 1B. When used to encapsulate the insulation layer, inner polymer layer 126 is in contact with insulation layer 110. Malleable layer 124 is disposed between outer polymer layer 122 and inner polymer layer 126.

In some electrical energy storage systems, a fluid transfer system is coupled to the electrical energy storage system. During use, the fluid transfer system passes a heat transfer fluid into the electrical energy storage system and collects the heat transfer fluid after the fluid passes through the electrical energy storage system. The fluid transfer system passes a dielectric liquid fluid or a dielectric gas into the electrical energy storage system. In some aspects, the fluid is heated or cooled such that the fluid heats or cools, respectively, the components in the electrical energy storage system.

Exemplary dielectric heat transfer fluids include, but are not limited to hydrocarbon fluids, ester fluids, silicone fluids, and fluoroether fluids. Hydrocarbon fluids that can be used for cooling components of an electrical energy storage system include, but are not limited to, aromatic hydrocarbons (e.g., diethyl benzene and dibenzyl toluene) and aliphatic hydrocarbons (e.g., paraffinic oil, iso-paraffinic oil, and polyalphaolefins). Ester fluids that can be used for cooling components of an electrical energy storage system include, but are not limited to, diester and polyolester heat transfer fluids. Silicone fluids that can be used for cooling components of an electrical energy storage system include, but are not limited to, dimethylpolysiloxane, methylphenylpolysiloxane, diphenylpolysiloxane, and halogenated polysiloxane. Fluoroether fluids that can be used for cooling components of an electrical energy storage include, but are not limited to, perfluoropolyether and hydrofluoroethers.

In one aspect of the present disclosure, the outer polymer layer comprises a polymer that is resistant to dielectric heat transfer fluids in the electrical energy storage system. In specific aspects of the present disclosure, the outer polymer layer comprises a polymer that is resistant to one or more heat transfer fluid commonly used in electrical energy storage systems. For example, the outer layer comprises a polymer that is resistant to hydrocarbon fluids, ester fluids, silicone fluids, fluoroether fluids, or any combination of these fluids. Exemplary polymers that me be used for the outer polymer layer include, but are not limited to, polyoxymethylene, acrylonitrile butadiene styrene, polyamide-imide, polyamide, polycarbonate, polyester, polyetherimide, polystyrene, polysulfone, polyimide, terephthalate, or combinations thereof.

Outer polymer layer can also provide wear protection to the insulation layer. During use, external stress can cause the insulation layer to be damaged. Damage to the insulation layer can compromise the heat insulation properties of the insulation layer. External stress that can occur to an unprotected insulation layer include, but are not limited to, stress caused by expansion of the battery cells, changes in ambient temperature, external impact, external rupture, and external scratching of the insulation layer. In some aspects of the present disclosure the outer polymer layer is selected from a material that protects the insulation layer from external stresses. Exemplary polymers that can be used as the outer polymer layer include, but are not limited to, polyethylene terephthalate (“PET”) and oriented nylon (“ONy”).

It should be understood that while a single outer polymer layer is described above, the outer polymer layer can be composed of two or more polymer layers. FIG. 1C depicts an aspect of the present disclosure with an outer layer composed of two different polymer layers 122a and 122b. When multiple outer polymers layers are used, the additional outer polymer layers may be formed from the same polymer or different polymers. In an aspect of the invention, the outer polymer layer is composed of an ONy polymer layer having an overlying PET polymer layer.

As shown in FIG. 1A, inner polymer layer 126 is in contact with insulation layer 110. Inner polymer layer 110 at least partially surround the insulation layer, protecting the insulation layer from external chemical and mechanical damage. The insulation layer also serves as a barrier that keeps particulate matter from the insulation layer contained within the encapsulation layer, inhibiting or preventing damage particles from being dispersed in the electrical energy storage system.

As is discussed herein, encapsulation layer 120 may be composed of two separate laminate films (e.g., a top film 120a and a bottom film 120b) which are connected to each other to form a seal around insulation layer 110. In an alternate aspect, the encapsulation layer can be formed from a single laminate film that is folded over and sealed to itself to encapsulate the insulation layer.

In one aspect, inner polymer layer 126 comprises a material that can be heat welded to itself. As shown in FIG. 1A, after encapsulating insulation layer 110, encapsulation layer 120 extends away from the insulation layer. The inner polymer layer disposed on, for example, the top face of the insulation layer can be heat welded to an inner polymer layer disposed on the bottom face of the insulation layer to form a seal around the insulation layer. A thermal seal may be formed by applying a heated object to the top laminate film and/or the bottom laminate film, is a position that is exterior to the insulation layer. Heat from the heated object will raise the temperature of the polymer to a point that the polymer used in the top and bottom layers can fuse together. An exemplary polymer that can be used as the inner layer of the laminate film is a polyolefin polymer. Examples of polyolefin polymers that can be used as the inner polymer layer include, but are not limited to, polyethylene and polypropylene.

The inner polymer layer can also provide chemical resistance and/or heat resistance to the insulation layer. During use, the temperature of battery cells can increase due to the electrical demands of the battery module. Likewise, battery modules can increase in temperature as the electrical demands on the battery pack increase. The increase in temperature of the components that are separated by the insulation layers can stress the insulation layer. Additionally, chemical leakage from battery cells can chemically damage an insulation layer, compromising the thermal properties of the insulation layer. In some aspects of the present invention, the inner polymer layer is chosen from a material that protects the insulation layer from chemical and heat damage. Polyolefin polymers provide good chemical and heat resistance to the insulation layer.

In one aspect, malleable layer 124 is disposed between inner polymer layer 126 and outer polymer layer 122. The malleable layer is used, in some aspects, to provide support and protection of the insulation barrier. For example, an insulation layer that comprises a woven or non-woven fibrous reinforcement support. Such support-based insulation layers, due to their light weight and low stiffness, can be difficult to install between in electrical energy storage system, particularly between battery cells. These difficulties are compounded in mass production settings. Placing a malleable layer in the encapsulation layer can act as a support which allows the insulation barrier to be more easily manipulated during manufacturing.

Malleable layers can also provide additional heat and mechanical protection when used in battery modules. In some aspects of the disclosure, the insulation barrier is placed between the battery cells in a battery module. During a thermal runaway event, a battery cells may explosively rupture, causing hot particles and gasses to be ejected throughout the module. These ejected materials can cause adjacent battery cells casings to be compromised, sometimes causing the adjacent battery cells to go into a runaway state. An insulation barrier comprising a malleable layer can inhibit or prevent particle natter and gasses from damaging adjacent battery cells. The malleable layer can also protect the insulation layer from moisture and air.

In one aspect, a malleable layer comprises a malleable polymer or a malleable metal foil. Aluminum is the most common metal used in a laminate encapsulation layer, however other malleable metal foils can be used such as stainless steel and copper foils.

Use of metal foils can also add heat transfer properties to the insulation barrier. When thermal runaway of a battery cells occurs, the battery cell heats to very high temperature. This heat can be radiated to adjacent battery cells, causing an increased chance of the adjacent battery cells entering a runaway state. Use of a metal foil can improve the heat properties of the insulation barrier by providing a thermally conductive metal foil in the insulation layer. The heat produced by an adjacent runaway battery cell can be transferred to the metal foil layer.

The metal foil layer can be connected to a portion of the casing (e.g., a cooling plate) that allows the heat to be transferred away from the battery cells through the metal foil.

As discussed herein, the encapsulation layer is composed of a laminate structure comprising an outer polymer layer, an inner polymer layer and a malleable layer disposed between the polymer layers. In some aspects, the inner polymer layer is composed of a polymer material that is different from the polymer layer of the outer polymer layer. For example, the inner polymer layer can be composed of a material that can be easily fused together, while the outer polymer layer can be composed of a material that is resistant to a coolant fluid that is used in the electrical energy storage system.

The laminate film used as the encapsulation layer may be composed as a unitary film composed of multiple layers, as described herein. In an aspect, the laminate film can be formed by placing the malleable layer between the two polymer layers and using heat and/or pressure to fuse the inner and outer polymer layer together. In another aspect, an adhesive glue or tape can be used to hold the layers together. For example, an adhesive can be disposed between the outer polymer layer and the malleable layer and/or the inner polymer layer and the malleable layer.

In an aspect the thickness of the encapsulation layer is from about 30 μm to about 300 μm. The encapsulation layer can have a thickness of up to about 30 μm, up to about 40 μm, up to about 50 μm, up to about 60 μm, up to about 70 μm, up to about 80 μm, up to about 90 μm, up to about 100 μm, up to about 120 μm, up to about 150 μm, up to about 200 μm, up to about 250 μm, or up to about 300 μm. When the encapsulation layer is a laminate film, the inner polymer layer can have a thickness from about 10 μm to about 100 μm; the malleable layer can have a thickness from about 10 μm to about 100 μm; and the outer polymer layer can have a thickness from about 10 μm to about 100 μm.

The insulation layer of the present disclosure e.g. an insulation layer including an aerogel, can retain or increase insubstantial amounts in thermal conductivity (commonly measured in mW/m-k) under a load of up to about 5 MPa. In certain embodiments, insulation layer of the present disclosure has a thermal conductivity through a thickness dimension of said insulation layer about 50 mW/mK or less, about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values at 25° C. under a load of up to about 5 MPa. The thickness of the aerogel insulation layer may be reduced as a result of the load experienced by the aerogel insulation layer. For example, the thickness of the aerogel insulation layer may be reduced by 50% or lower, 40% or lower, 30% or lower, 25% or lower, 20% or lower, 15% or lower, 10% or lower, 5% or lower, or in a range between any two of these values under a load in the range of about 0.50 MPa to 5 MPa. Although the thermal resistance of the insulation layer including an aerogel may be reduced as the thickness is reduced, the thermal conductivity can be retained or increase by insubstantial amounts.

In one aspect, the encapsulation layer completely surrounds the insulation layer. Complete encapsulation of the insulation layer can be accomplished by heat welding two laminate films together. As used herein the term “heat welding” refers to a process connecting two pieces of polymeric materials by fusing with heat. In a heat welding process, one, or both, of the polymeric pieces are heated above the glass transition temperature of the material used to form one, or both, of the polymeric pieces. Heating the polymeric pieces above the glass transition temperature causes the material of one or both pieces to become soft and fuse with the other piece.

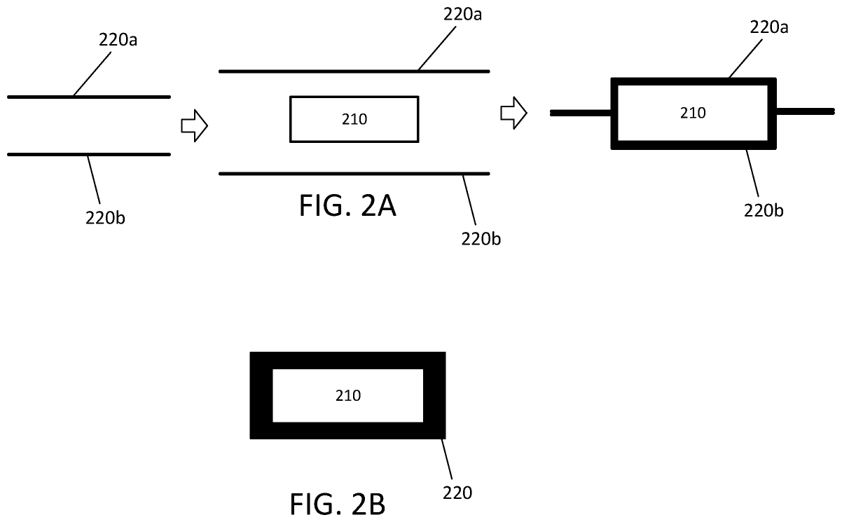

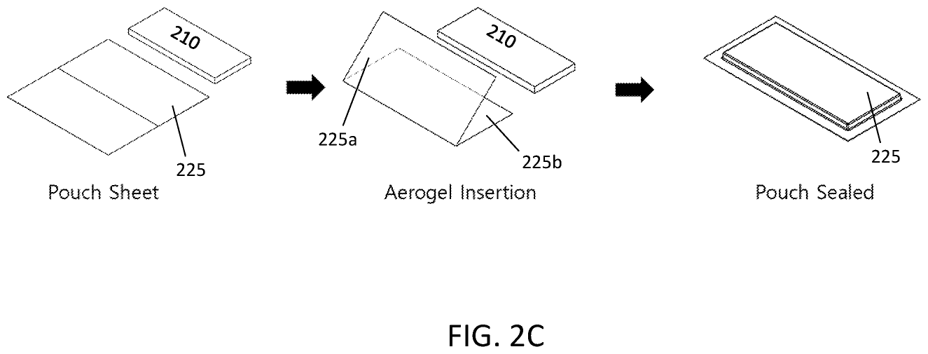

In one aspect, a method of encapsulating an insulation layer comprises: surrounding at least a portion of the insulation layer with a laminate film, as described herein, and heat welding the laminate film to form an encapsulation layer, wherein the encapsulation layer at least partially surrounds the insulation layer. FIG. 2A shows one aspect of a method of encapsulating an insulation layer. In this aspect, two separate laminate films 220a and 220b each cover at least a portion of an insulation layer 210. For example, a first laminate film 220a can cover the top face of the insulation layer and a second laminate film 220b can cover the lower face of the insulation layer. Both the first and second laminate films are placed such that the inner polymer layers are in contact with each other. The encapsulation layer can be formed by heat welding a portion of the first laminate film to the second laminate film. For example, a heated element in the general shape of the insulation layer may be contacted with first laminate film and pressed onto the first laminate film. The heated clement causes the inner polymer layer of the first laminate film to fuse with the inner polymer layer of the second laminate film. FIG. 2B shows a schematic diagram of the completely encapsulated insulation layer.

In another aspect, an insulation layer is encapsulated by surrounding at least a portion of the insulation layer with a laminate film, as described herein, and heat welding the laminate film to form an encapsulation layer that at least partially surrounds the insulation layer. FIG. 2C shows one aspect of a method of encapsulating an insulation layer. In this aspect, a single laminate film 225 is folded over on itself so that each section of the single laminate film covers at least a portion of an insulation layer 210. For example, a first section of the laminate film 225a can cover the top face of the insulation layer and a second section of the laminate film 225b can cover the lower face of the insulation layer. Both the first and second sections of the laminate films are placed such that the inner polymer layers are in contact with each other. The encapsulation layer can be formed by heat welding a portion of the first laminate film to the second laminate film. For example, a heated element in the general shape of the insulation layer may be contacted with first laminate film and pressed onto the first laminate film. The heated element causes the inner polymer layer of the first laminate film to fuse with the inner polymer layer of the second laminate film.

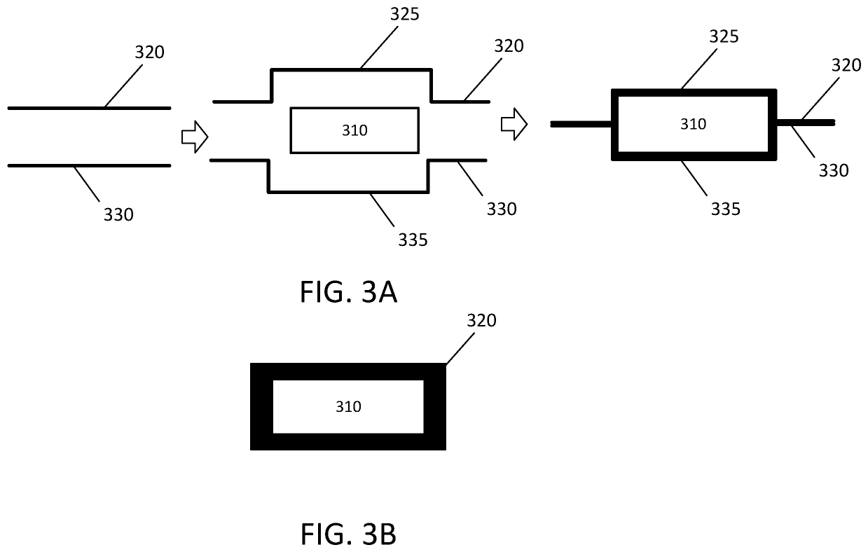

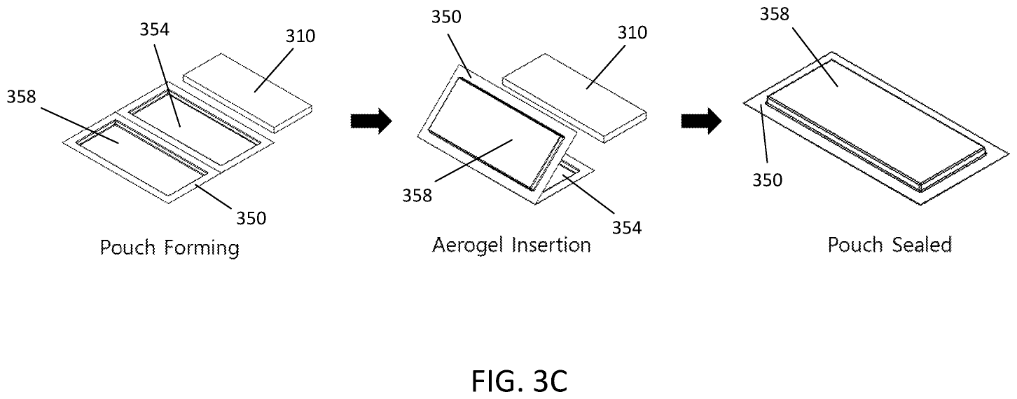

As depicted in FIG. 3A, a method of encapsulating an insulation layer 310 comprises forming a first indentation 325 in a first laminate film 320. First indentation 325 is formed by bending the laminate film into a shape that is complementary in shape and size to the insulation layer. The presence of a malleable layer in the laminate film allows the first indentation to be formed and retain the desired shape and size. A second indentation 335 is formed in the second laminate film 330. Both the first and second laminate films are placed such that the insulation layer is positioned in the indentations. For example, in one aspect, insulation layer 310 is initially placed into second indentation 335. First laminate film 320 is then placed on top of the second laminate film such that the insulation layer is positioned in first indentation 325. The encapsulation layer can be completed by heat welding a portion of the first laminate film to the second laminate film. FIG. 3B shows a top view of the completely encapsulated insulation layer.

In an alternate embodiment, the encapsulation layer is sealed to itself. In this alternate embodiment, a single encapsulation layer is long enough to be folded over itself and surround the insulation layer. Once folded over, the encapsulation layer is heat welded to itself to encapsulate the insulation layer. FIG. 3C depicts a schematic diagram of a method of encapsulating an insulation layer 310 with an encapsulation layer 350 comprising a single laminate film. A first indentation 354 and a second indentation 358 are formed in the laminate film 350. Both indentations have a size and shape that is complementary in size and shape to the insulation layer. In this embodiment, the encapsulation layer is formed by placing the insulation layer 310 in the first indentation 354. The laminate film is folded over itself such that the second indentation 358 is substantially aligned with the first indentation 354. The encapsulation layer can be completed by heat welding a portion of the first laminate film to the second laminate film.

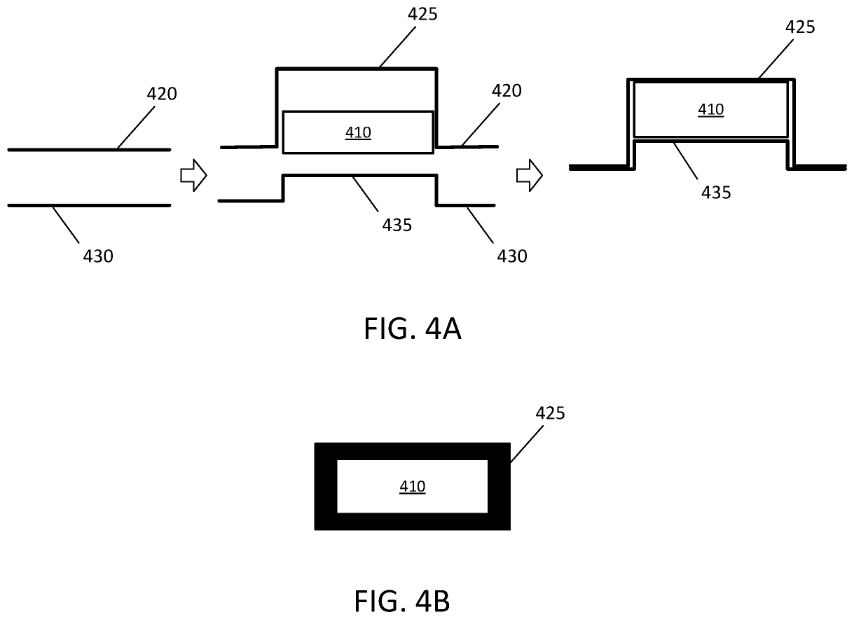

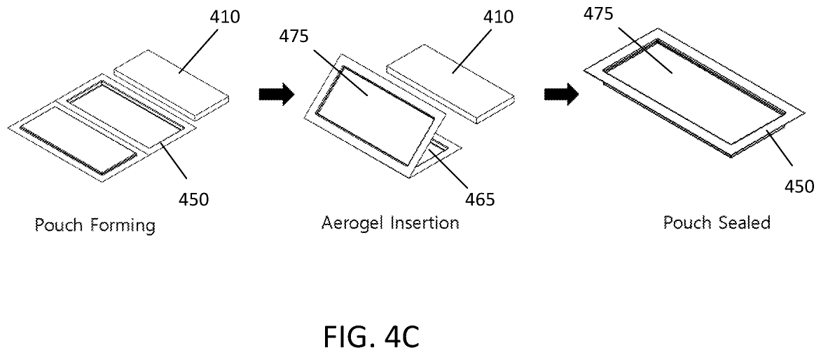

An alternate method of encapsulating an insulation layer is shown in FIG. 4A. In this alternate aspect, a method of encapsulating an insulation layer 410 comprises forming a first indentation 425 in a first laminate film 420. First indentation 425 is formed by bending the laminate film into a shape that is complementary in shape and size to the insulation layer. A second indentation 435 is formed in the second laminate film 430. Second indentation 435 has a shape and size that is complementary in shape and size to the first indentation. Specifically, second indentation 435 is in a shape and size to allow the indented portion of the second laminate film to fit into the first indentation. Both the first and second laminate films are placed such that the insulation layer is positioned in first indentation 425 and on the second indentation 435, as shown in FIG. 4A. For example, in one aspect, insulation layer 410 is initially placed into first indentation 425. Second laminate film 430 is then placed in contact with the first laminate film such that the insulation layer is positioned in first indentation 425 and on the second indentation 435. The encapsulation layer can be completed by heat welding a portion of the first laminate film to the second laminate film. FIG. 4B shows a top view of the completely encapsulated insulation layer.

In another aspect, a single laminate film is used to form an encapsulated insulation layer. FIG. 4C depicts an embodiment in which a single laminate film 450 is folded over onto itself so that each section of the single laminate film covers at least a portion of an insulation layer 410. In an embodiment, a first indentation 465 is formed in a first section of the laminate film. First indentation 465 is formed by bending the laminate film into a shape that is complementary in shape and size to the insulation layer. A second indentation 475 is formed in a second section of laminate film. Second indentation 475 has a shape and size that is complementary in shape and size to the first indentation. Specifically, second indentation 475 is in a shape and size to allow the indented portion of the second laminate film to fit into the first indentation. The first section of the laminate film and the second section of the laminate film is positioned such that the insulation layer is positioned in first indentation 465 and on the second indentation 475, as shown in FIG. 4C. For example, in one aspect, insulation layer 410 is initially placed into first indentation 465. Second section of laminate film 450 is folded over and placed in contact with the first laminate film such that the insulation layer is positioned in first indentation 465 and in contact with the second indentation 475. The encapsulation layer can be completed by heat welding a portion of the first section of the laminate film to a portion of the second section of the laminate film to form the encapsulated insulation layer.

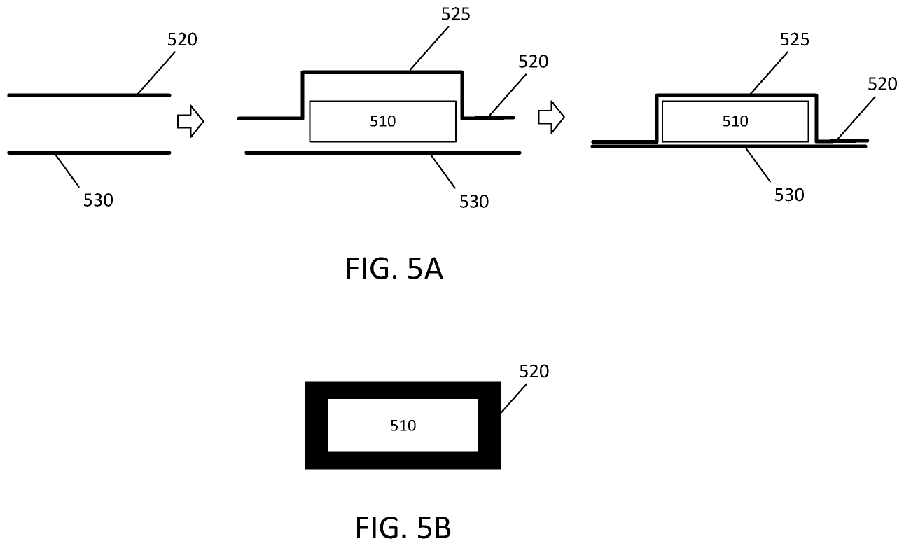

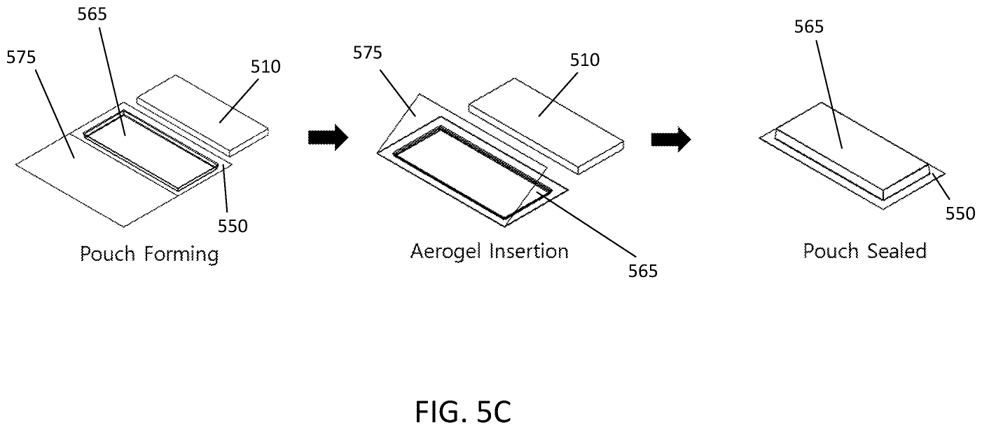

An alternate method of encapsulating an insulation layer is shown in FIG. 5A. As depicted in FIG. 5A, a method of encapsulating an insulation layer 510 comprises forming a first indentation 525 in a first laminate film 520. Insulation layer 510 is positioned in first indentation 525. Second laminate film 530 is then placed in contact with the first laminate film such that the insulation layer is covered by the second laminate film. The encapsulation layer can be completed by heat welding a portion of the first laminate film to the second laminate film. FIG. 5B shows a top view of the completely encapsulated insulation layer.

FIG. 5C depicts an embodiment in which a single laminate film 550 is folded over onto itself so that each section of the single laminate film covers at least a portion of an insulation layer 510. As shown in FIG. 5C, a first indentation 565 is formed in a first section of laminate film 550. Insulation layer 510 is positioned in first indentation 565. Second section 575 of laminate film 550 is then placed in contact with the first section of the laminate film such that the insulation layer is covered by the second section of the laminate film. The encapsulation layer can be completed by heat welding a portion of the first section of the laminate film to a portion of the second section of the laminate film.

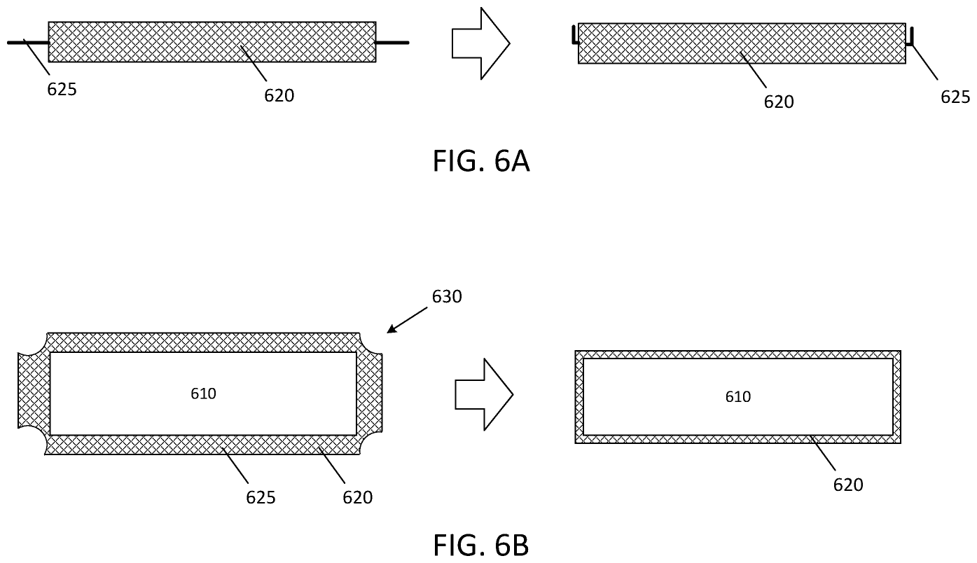

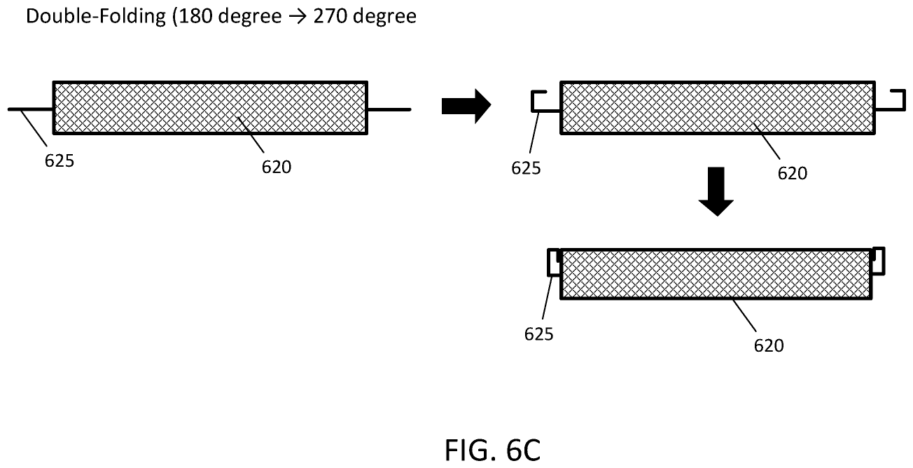

After the encapsulation layer has been formed, for example, by heat welding laminate film(s), there may be some additional material surrounding the insulation layer, typically the portion of the encapsulation layer that is heat welded together. As shown in FIG. 6A, an insulation layer is encapsulated by encapsulation layer 620. The portion of the encapsulation layer that was heat welded, 625, extends out away from the insulation layer. This can be problematic in some energy storage systems where there is very little, if any, additional space to accommodate these extended portions. In the present aspect, the extended portions 625 may be folded back toward the insulation layer to reduce the size of the insulation barrier. In an alternate aspect, depicted in FIG. 6B, cut-outs 630 can be formed in the extended portion 625. The cutouts allow the extended portion to be more easily folded, without creating bulging material at the corners where the material could be doubled if each edge of the encapsulation is folded toward the insulation layer. In some aspects, a double fold may be used.

FIG. 6C depicts an embodiment where the edges are folded twice. In FIG. 6C, an insulation layer (not shown) is encapsulated by encapsulation layer 620. The portion of the encapsulation layer that was heat welded, 625, extends out away from the insulation layer. The first fold is a 180-degree fold, with the edge material folded over itself. To further reduce the extended edges, the edge material is folded a second time, by 90 degrees so that the edge material is folded against the side of the pouch.

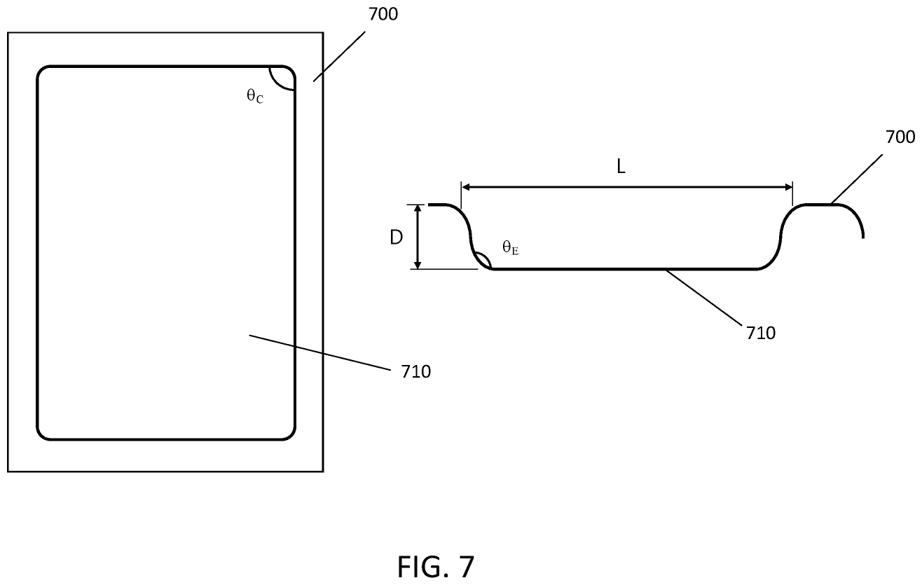

When indentations are used to form a pouch around an insulation barrier, the physical parameters of the indentation can be optimized to improve the encapsulation of the insulation layer. FIG. 7 depicts a schematic diagram of an indentation 710 formed in a laminate film 700. Parameters of the indentation that can be altered to improve the encapsulation of the insulation layer includes depth (D); length (L), angle of the indentation corner θ_{C}, and radius of edge θ_{E}. The factors can be optimized to take into account the malleable layer material and its thickness.

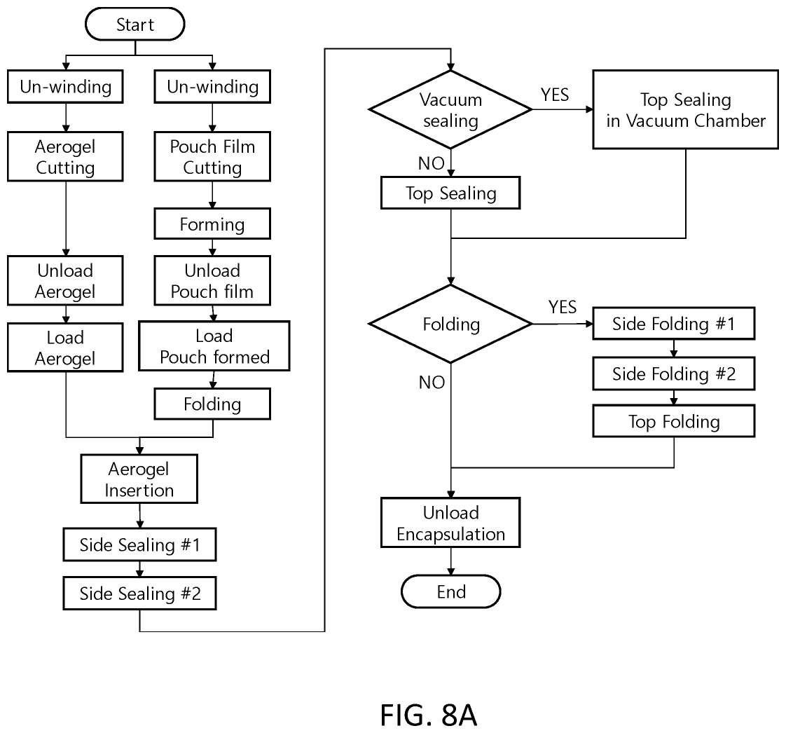

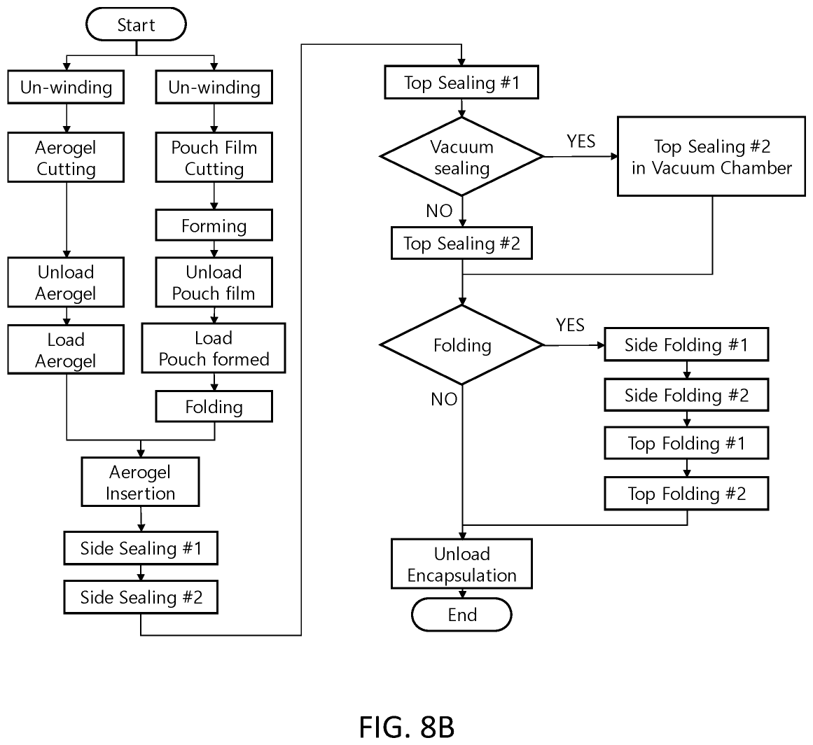

FIG. 8A shows the general assembly process for encapsulation of an insulation layer using a single laminate film. In a general assembly process, both the laminate film and the insulation layer material are supplied as rolls feeding into the assembly process. At the start, both the laminate film and the insulation layer material are unwound from the roll for processing. The laminate film is cut into the predetermined length needed for encapsulation and any indentations that are needed for processing are formed in the laminate film. The insulation layer (in this example an aerogel insulation layer) is also cut into the predetermined length needed for use as a thermal barrier between battery cells or modules. The cut materials are removed from the cutting machine and prepared for assembly. In this example, a single laminate sheet is used to encapsulate the insulation layer by folding the laminate sheet onto itself. The laminate film is prepared by forming a fold line or a crease in the laminate film. The insulation layer (aerogel) is then placed in the appropriate portion of the laminate film and the film prepared for heat sealing. Two sides of the laminate film are heat welded to each other to partially enclose the insulation layer, forming a bag like enclosure having an open end. In some aspects, the open end of the bag is heat welded to complete enclosure of the insulation layer. In an alternate aspect, the partially encapsulated insulation layer is placed in a vacuum chamber. Once a vacuum is drawn in the chamber, the open end of the encapsulation layer is sealed completing the full enclosure of the insulation layer under vacuum. The process is completed by an optional side folding of the heat welded ends of the encapsulation layer.

FIG. 8B shows the general assembly process for encapsulation of an insulation layer using two laminate films. As discussed above, both the laminate film and the insulation layer material are supplied as rolls feeding into the assembly process. At the start, both the laminate film and the insulation layer material are unwound from the roll for processing. The laminate film is cut into two separate pieces at the predetermined length needed for encapsulation and any indentations that are needed for processing are formed in the laminate films. The insulation layer (in this example an aerogel insulation layer) is also cut into the predetermined length needed for use as a thermal barrier between battery cells or modules. The cut materials are removed from the cutting machine and prepared for assembly. In this example, a two laminate sheets are used to encapsulate the insulation layer. The insulation layer (aerogel) is placed in the appropriate portion of the laminate film and the film prepared for heat sealing. Two sides and one end of the laminate film are heat welded to each other to partially enclose the insulation layer, forming a bag like enclosure having an open end. In some aspects, the open end of the bag is simply heat welded to complete enclosure of the insulation layer. In an alternate aspect, the partially encapsulated insulation layer is placed in a vacuum chamber. Once a vacuum is drawn in the chamber, the open end of the encapsulation layer is sealed completing the full enclosure of the insulation layer under vacuum. The process is completed by an optional side folding of the heat welded ends of the encapsulation layer.

A testing protocol was developed to determine effectiveness of the insulation barriers described herein. The testing protocol tests the ability of the insulation barrier to resist high temperatures and the impact of heated particles. This mimics the rupture conditions that can occur during thermal runaway of a battery cell. In both tests, the insulation barrier is coupled to a metal support plate (e.g., a stainless-steel plate). A heat sensor is attached to the support plate to monitor the temperature of the metal support plate during use.

To test heat resistance of the insulation barrier, an insulation barrier is coupled to the support plate and subjected to a flame test. A propane torch (Benzomatic) is used to develop a temperature of about 1000° C. on the insulation barrier. The heat of the support plate can be monitored during testing to determine the heat resistance of the insulation layer. After the flame test is complete, the insulation layer is observed for damage. In an exemplary flame test protocol an insulation barrier is coupled to a support and a propane torch is used to heat the insulation layer at 1000° C. for two minutes. The insulation layer is then observed for damage.

The testing protocol also includes a heated particle test. In the heated particle test, the same flame test system is used but is modified to include heated particles. In an exemplary experiment, an insulation barrier mounted to a support is heated to about 1000° C. A stream of particles, that are inert to the operating temperature (about 1000° C.), were directed to the insulation barrier in such a way that the particles are heated up by the torch before hitting the insulation barrier. Heated particles were directed toward the insulation barrier for 10 s. After the heated particles were stopped, the insulation barrier was heated for 2 min at 1000° C. for 2 minutes without particles.

In both tests, the insulation barrier maintained its integrity and insulating properties. Although, the polymer layers burned off under the testing conditions, the malleable layer (stainless steel) and the insulating layer (aerogel) were only discolored. e encapsulation member can reduce or eliminate the generation of dust or particulate material shed from the insulation layer. Additionally, the encapsulating layer can be formed from a material that allows markings or printed writing to be made on the insulation barrier. The marking of the insulation layer is not always possible.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means ±5% of the numerical. In an embodiment, the term “about” can include traditional rounding according to significant figures of the numerical value. In addition, the phrase “about ‘x’ to ‘y’” includes “about ‘x’ to about ‘y’”.

Within the context of the present disclosure, the term “aerogel”, “aerogel material” or “aerogel matrix” refers to a gel comprising a framework of interconnected structures, with a corresponding network of interconnected pores integrated within the framework, and containing gases such as air as a dispersed interstitial medium; and which is characterized by the following physical and structural properties (according to Nitrogen Porosimetry Testing) attributable to aerogels: (a) an average pore diameter ranging from about 2 nm to about 100 nm, (b) a porosity of at least 80% or more, and (c) a surface area of about 100 m²/g or more.

Aerogel materials of the present disclosure thus include any aerogels or other open-celled materials which satisfy the defining elements set forth in previous paragraphs; including materials which can be otherwise categorized as xerogels, cryogels, ambigels, microporous materials, and the like.

Within the context of the present disclosure, references to “thermal runaway” generally refer to the sudden, rapid increase in cell temperature and pressure due various operational factors and which in turn can lead to propagation of excessive temperature throughout an associated module. Potential causes for thermal runaway in such systems may, for example, include: cell defects and/or short circuits (both internal and external), overcharge, cell puncture or rupture such as in the event of an accident, and excessive ambient temperatures (e.g., temperatures typically greater than 55° C.). In normal use, the cells heat as result of internal resistance. Under normal power/current loads and ambient operating conditions, the temperature within most Li-ion cells can be relatively easily controlled to remain in a range of 20° C. to 55° C. However, stressful conditions such as high-power draw at high cell/ambient temperatures, as well as defects in individual cells, may steeply increase local heat generation. In particular, above the critical temperature, exothermic chemical reactions within the cell are activated. Moreover, chemical heat generation typically increases exponential with temperature. As a result, heat generation becomes much greater than available heat dissipation. Thermal runaway can lead to cell venting and internal temperatures in excess of 200° C.

Within the context of the present disclosure, the terms “flexible” and “flexibility” refer to the ability of a material or composition to be bent or flexed without macrostructural failure. Insulation layer of the present disclosure are capable of bending at least 5°, at least 25°, at least 45°, at least 65°, or at least 85° without macroscopic failure; and/or have a bending radius of less than 4 feet, less than 2 feet, less than 1 foot, less than 6 inches, less than 3 inches, less than 2 inches, less than 1 inch, or less than U inch without macroscopic failure. Likewise, the terms “highly flexible” or “high flexibility” refer to materials capable of bending to at least 90° and/or have a bending radius of less than U inch without macroscopic failure. Furthermore, the terms “classified flexible” and “classified as flexible” refer to materials or compositions which can be classified as flexible according to ASTM CI 101 (ASTM International, West Conshohocken, PA).

Insulation layer of the present disclosure can be flexible, highly flexible, and/or classified flexible. Aerogel compositions of the present disclosure can also be drapable. Within the context of the present disclosure, the terms “drapable” and “drapability” refer to the ability of a material to be bent or flexed to 90° or more with a radius of curvature of about 4 inches or less, without macroscopic failure. Insulation layer according to certain embodiments of the current disclosure are flexible such that the composition is non-rigid and may be applied and conformed to three-dimensional surfaces or objects, or pre-formed into a variety of shapes and configurations to simplify installation or application.

Within the context of the present disclosure, the terms “thermal conductivity” and “TC” refer to a measurement of the ability of a material or composition to transfer heat between two surfaces on either side of the material or composition, with a temperature difference between the two surfaces. Thermal conductivity is specifically measured as the heat energy transferred per unit time and per unit surface area, divided by the temperature difference. It is typically recorded in SI units as mW/m*K (milliwatts per meter*Kelvin). The thermal conductivity of a material may be determined by test methods known in the art, including, but not limited to Test Method for Steady-State Thermal Transmission Properties by Means of the Heat Flow Meter Apparatus (ASTM C518, ASTM International, West Conshohocken, PA); a Test Method for Steady-State Heat Flux Measurements and Thermal Transmission Properties by Means of the Guarded-Hot-Plate Apparatus (ASTM C177, ASTM International, West Conshohocken, PA); a Test Method for Steady-State Heat Transfer Properties of Pipe Insulation (ASTM C335, ASTM International, West Conshohocken, PA); a Thin Heater Thermal Conductivity Test (ASTM C1114, ASTM International, West Conshohocken, PA); Standard Test Method for Thermal Transmission Properties of Thermally Conductive Electrical Insulation Materials (ASTM D5470, ASTM International, West Conshohocken, PA); Determination of thermal resistance by means of guarded hot plate and heat flow meter methods (EN 12667, British Standards Institution, United Kingdom); or Determination of steady-state thermal resistance and related properties-Guarded hot plate apparatus (ISO 8203, International Organization for Standardization, Switzerland). Due to different methods possibly resulting in different results, it should be understood that within the context of the present disclosure and unless expressly stated otherwise, thermal conductivity measurements are acquired according to ASTM C518 standard (Test Method for Steady-State Thermal Transmission Properties by Means of the Heat Flow Meter Apparatus), at a temperature of about 37.5° C. at atmospheric pressure in ambient environment, and under a compression load of about 2 psi. The measurements reported as per ASTM C518 typically correlate well with any measurements made as per EN 12667 with any relevant adjustment to the compression load.

Thermal conductivity measurements can also be acquired at a temperature of about 10° C. at atmospheric pressure under compression. Thermal conductivity measurements at 10° C. are generally 0.5-0.7 mW/mK lower than corresponding thermal conductivity measurements at 37.5° C. In certain embodiments, the insulation layer of the present disclosure has a thermal conductivity at 10° C. of about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values.

### Use of the Insulation Barriers within Battery Module or Pack

Lithium-ion batteries (LIBs) are considered to be one of the most important energy storage technologies due to their high working voltage, low memory effects, and high energy density compared to traditional batteries. However, safety concerns are a significant obstacle that hinders large-scale applications of LIBs. Under abuse conditions, exothermic reactions may lead to the release of heat that can trigger subsequent unsafe reactions. The situation worsens, as the released heat from an abused cell can activate a chain of reactions, causing catastrophic thermal runaway.

With continuous improvement of LIBs in energy density, enhancing their safety is becoming increasingly urgent for the development of electrical devices e.g. electrical vehicles. The mechanisms underlying safety issues vary for each different battery chemistry. The present technology focuses on tailoring insulation barrier and corresponding configurations of those tailored barriers to obtain favorable thermal and mechanical properties. The insulation barriers of the present technology provide effective heat dissipation strategies under normal as well as thermal runaway conditions, while ensuring stability of the LIB under normal operating modes (e.g., withstanding applied compressive stresses).

The insulation barriers disclosed herein are useful for separating, insulating and protecting battery cells or battery components of batteries of any configuration, e.g., pouch cells, cylindrical cells, prismatic cells, as well as packs and modules incorporating or including any such cells. The insulation barriers disclosed herein are useful in rechargeable batteries e.g., lithium-ion batteries, solid state batteries, and any other energy storage device or technology in which separation, insulation, and protection are necessary.

Passive devices such as cooling systems may be used in conjunction with the insulation barriers of the present disclosure within the battery module or battery pack.

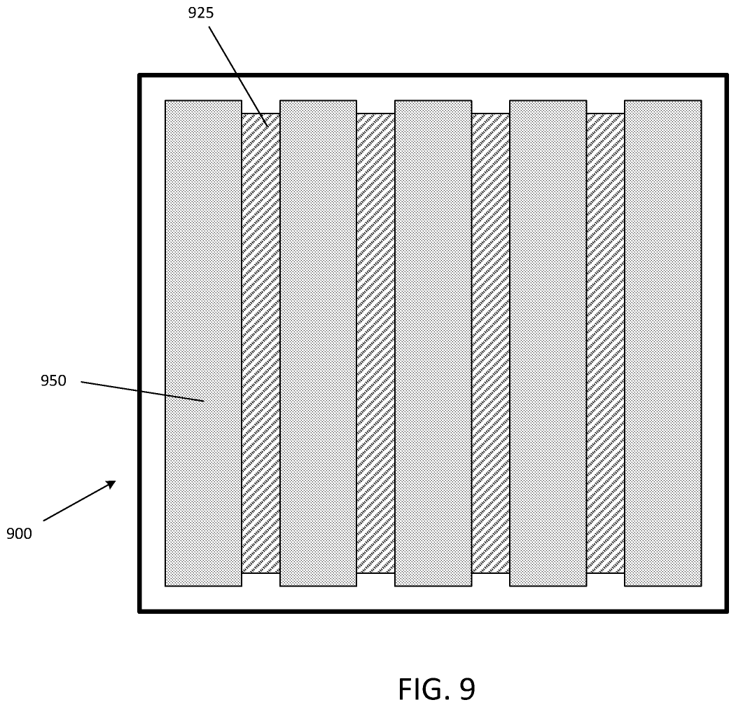

The insulation barrier according to various embodiments of the present disclosure in a battery pack including a plurality of single battery cells or of modules of battery cells for separating said single battery cells or modules of battery cells thermally from one another. A battery module is composed of multiple battery cells disposed in a single enclosure. A battery pack is composed of multiple battery modules. FIG. 9 depicts an embodiment of a battery module 900 having a plurality of battery cells 950. Encapsulated insulation barriers 925 are positioned between battery cells 950. The encapsulated insulation barrier can inhibit or prevent damage of adjacent battery cells when a battery cell undergoes thermal runaway or any other catastrophic batter cell failure.

Battery modules and battery packs can be used to supply electrical energy to a device or vehicles. Device that use battery modules or battery packs include, but are not limited to, a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. When used in a vehicle, a battery pack can be used for an all-electric vehicle, or in a hybrid vehicle.

Aspects of the disclosure are set out in the following numbered clauses:

1. An insulation barrier for use in an electrical energy storage system, the insulation barrier comprising:
at least one insulation layer; and
an encapsulation layer at least partially surrounding the insulation layer, wherein the encapsulation layer comprises a laminate film comprising an outer polymer layer, a malleable layer comprising a malleable material, and an inner polymer layer, wherein the inner polymer layer is in contact with the insulation layer and wherein the malleable layer is disposed between the outer polymer layer and the inner polymer layer.
   2. The insulation barrier of clause 1, wherein the outer polymer layer comprises a polymer that is resistant to dielectric heat transfer fluids in the electrical energy storage system.
   3. The insulation barrier of clause 2, wherein the outer polymer layer comprises a polymer that is resistant to a heat transfer fluid selected from the group consisting of hydrocarbon fluids, ester fluids, silicone fluids, fluoroether fluids, and mixtures thereof.
   4. The insulation barrier of any one of the preceding clauses, wherein the outer polymer layer is made from a polymer selected from the group consisting of polyoxymethylene, acrylonitrile butadiene styrene, polyamide-imide, polyamide, polycarbonate, polyester, polyetherimide, polystyrene, polysulfone, polyimide, and terephthalate.
   5. The insulation barrier of any one of the preceding clauses, wherein the inner polymer layer is composed of a polymer that can be heat welded to itself.
   6. The insulation barrier of any one of the preceding clauses, wherein the inner polymer layer is composed of a polyolefin polymer.
   7. The insulation barrier of any one of the preceding clauses, wherein the inner polymer layer is composed of a polymer that is different from the polymer in the outer polymer layer.
   8. The insulation barrier of any one of the preceding clauses, wherein the outer polymer layer is composed of polyethylene terephthalate (“PET”) or oriented nylon (“ONy”), and wherein the inner polymer layer is composed of polypropylene (“PP”).
   9. The insulation barrier of any one of the preceding clauses, wherein the outer polymer layer is composed of a first polymer film composed of a first material and a second polymer film composed of a second material, wherein the first material is different from the second material.
   10. The insulation barrier of any one of the preceding clauses, wherein the malleable layer comprises a metal foil.
   11. The insulation barrier of any one of clauses 1-10, wherein the malleable layer comprises a malleable polymer.
   12. The insulation barrier of any one of the preceding clauses, wherein the encapsulation layer further comprises an adhesive disposed between the outer polymer layer and the malleable layer and/or the inner polymer layer and the malleable layer.
   13. The insulation barrier of any one of the preceding clauses, wherein the outer polymer layer has a thickness of about 10 μm to about 100 μm.
   14. The insulation barrier of any one of the preceding clauses, wherein the malleable layer has a thickness of about 10 μm to about 100 μm.
   15. The insulation barrier of any one of the preceding clauses, wherein the inner polymer layer has a thickness of about 10 μm to about 100 μm.
   16. The insulation barrier of any one of the preceding clauses, wherein the encapsulation layer has a total thickness of between about 30 μm to about 300 μm.
   17. The insulation barrier of any one of the preceding clauses, wherein the insulation layer has a thermal conductivity through a thickness dimension of said insulation layer of less than about 50 mW/m-K at 25° C. and less than about 60 mW/m-K at 600° C.
   18. The insulation barrier of any one of the preceding clauses, wherein the insulation layer comprises an aerogel.
   19. The insulation barrier of any one of the preceding clauses, wherein the encapsulation layer completely surrounds the insulation layer.
   20. The insulation barrier of any one of the preceding clauses, wherein the encapsulation layer is composed of two laminate films heat welded together.
   21. The insulation barrier of any one of the preceding clauses, wherein the encapsulation layer surrounds the insulation layer, and wherein the encapsulation layer is heat welded to itself to form an enclosure at least partially surrounding the insulation layer.
   22. A battery module comprising:
a plurality of battery cells, and
one or more insulation barriers according to any one of the clauses 1-21, wherein at least one insulation barrier is disposed between adjacent battery cells.
   23. An electrical power system comprising one or more battery modules as described in clause 22.
   24. A device or vehicle comprising an electrical power system according to clause 23.
   25. The device of clause 24, wherein said device is a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool.
   26. The vehicle of clause 24, wherein the vehicle is an electric vehicle.
   27. A method of encapsulating an insulation layer for use between battery cells in an electrical energy storage system, the method comprising:
surrounding at least a portion of the insulation layer with a laminate film comprising an outer polymer layer, a malleable layer comprising a malleable material, and an inner polymer layer, wherein the inner polymer layer is in contact with the insulation layer and wherein the malleable layer is disposed between the outer polymer layer and the inner polymer layer; and heat welding the laminate film to form an encapsulation layer, wherein the encapsulation layer at least partially surrounds the insulation layer.
   28. The method of clause 27, wherein forming the encapsulation layer comprises:
covering at least a portion of the insulation layer with a first laminate film;
covering at least a portion of the insulation layer with a second laminate film; and
heat welding a portion of the first laminate film to the second laminate film to form the encapsulation layer.
   29. The method of clause 28, wherein:
a first indentation is formed in the first laminate film, the first indentation complementary in shape and size to the insulation layer;
a second indentation is formed in the second laminate film, the second indentation complementary in shape and size to the insulation layer; and
wherein forming the encapsulation layer comprises: placing the insulation layer in the first indentation of the first laminate film;
placing the second laminate film on the first laminate film with the second indentation substantially aligned with the first indentation; and
heat welding a portion of the first laminate film to a portion of the second laminate film.
   30. The method of clause 28, wherein:
a first indentation is formed in the first laminate film, the first indentation complementary in shape and size to the insulation layer;
a second indentation is formed in the second laminate film, the second indentation complementary in shape and size to the first indentation; and
wherein forming the encapsulation layer comprises:
   placing the insulation layer in the first indentation of the first laminate film;
placing the second laminate film on the first laminate film with the second indentation substantially aligned with the first indentation such that a portion of the second indention is disposed inside the first indentation; and
heat welding a portion of the first laminate film to a portion of the second laminate film.
   31. The method of clause 28, wherein:
a first indentation is formed in the first laminate film, the first indentation complementary in shape and size to the insulation layer;
wherein forming the encapsulation layer comprises:
   placing the insulation layer in the first indentation of the first laminate film;
placing the second laminate film on the first laminate film; and
heat welding a portion of the first laminate film to a portion of the second laminate film.
   32. The method of clause 27, wherein:
a first indentation is formed in the laminate film, the first indentation complementary in shape and size to the insulation layer;
a second indentation is formed in the laminate film, the second indentation complementary in shape and size to the insulation layer; and
   wherein forming the encapsulation layer comprises:
placing the insulation layer in the first indentation of the laminate film;
folding the laminate film such that the second indentation of the laminate film is substantially aligned with the first indentation; and heat welding a portion of the laminate film to itself.
   33. The method of clause 27, wherein:
a first indentation is formed in the laminate film, the first indentation complementary in shape and size to the insulation layer; and
   wherein forming the encapsulation layer comprises:
placing the insulation layer in the first indentation of the laminate film;
folding the laminate film such that a portion of the laminate film substantially covers the insulation layer and a separate portion of the laminate film; and
heat welding a portion of the laminate film to itself.
   34. The method of any one of clauses 27 to 33, wherein the encapsulation layer completely surrounds the insulation layer.
   35. The method of any one of clauses 27 to 34, wherein the heat welded portions of the laminate film are folded against one or more sides of the insulation layer.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

When used in this specification and claims, the terms “comprises” and “comprising” and variations thereof mean that the specified features, steps or integers are included. The terms are not to be interpreted to exclude the presence of other features, steps or components.

Although certain example embodiments of the invention have been described, the scope of the appended claims is not intended to be limited solely to these embodiments. The claims are to be construed literally, purposively, and/or to encompass equivalents.

1. An insulation barrier for use in an electrical energy storage system, the insulation barrier comprising:
at least one insulation layer; and
an encapsulation layer at least partially surrounding the insulation layer, wherein the encapsulation layer comprises a laminate film comprising an outer polymer layer, a malleable layer comprising a malleable material, and an inner polymer layer, wherein the inner polymer layer is in contact with the insulation layer and wherein the malleable layer is disposed between the outer polymer layer and the inner polymer layer.

2. The insulation barrier of claim 1, wherein the outer polymer layer comprises a polymer that is resistant to dielectric heat transfer fluids in the electrical energy storage system.

3. The insulation barrier of claim 2, wherein the outer polymer layer comprises a polymer that is resistant to a heat transfer fluid selected from the group consisting of hydrocarbon fluids, ester fluids, silicone fluids, fluoroether fluids, and mixtures thereof.

4. The insulation barrier of claim 1, wherein the outer polymer layer is made from a polymer selected from the group consisting of polyoxymethylene, acrylonitrile butadiene styrene, polyamide-imide, polyamide, polycarbonate, polyester, polyetherimide, polystyrene, polysulfone, polyimide, and terephthalate.

5. The insulation barrier of claim 1, wherein the inner polymer layer is composed of a polymer that can be heat welded to itself.

6. The insulation barrier of claim 1, wherein the inner polymer layer is composed of a polyolefin polymer.

7. The insulation barrier of claim 1, wherein the inner polymer layer is composed of a polymer that is different from the polymer in the outer polymer layer.

8. The insulation barrier of claim 1, wherein the outer polymer layer is composed of polyethylene terephthalate (“PET”) or oriented nylon (“ONy”), and wherein the inner polymer layer is composed of polypropylene (“PP”).

9. The insulation barrier of claim 1, wherein the outer polymer layer is composed of a first polymer film composed of a first material and a second polymer film composed of a second material, wherein the first material is different from the second material.

10. The insulation barrier of claim 1, wherein the malleable layer comprises a metal foil.

11. The insulation barrier of claim 1, wherein the malleable layer comprises a malleable polymer

12. The insulation barrier of any one of the preceding claims claim 1, wherein the encapsulation layer further comprises an adhesive disposed between the outer polymer layer and the malleable layer and/or the inner polymer layer and the malleable layer.

13. The insulation barrier of any one of the preceding claims claim 1, wherein the outer polymer layer has a thickness of about 10 μm to about 100 μm.

14. The insulation barrier of claim 1, wherein the malleable layer has a thickness of about 10 μm to about 100 μm.

15. The insulation barrier of claim 1, wherein the inner polymer layer has a thickness of about 10 μm to about 100 μm.

16. The insulation barrier of claim 1, wherein the encapsulation layer has a total thickness of between about 30 μm to about 300 μm.

17. The insulation barrier of claim 1, wherein the insulation layer has a thermal conductivity through a thickness dimension of said insulation layer of less than about 50 mW/m-K at 25° C. and less than about 60 mW/m-K at 600° C.

18. The insulation barrier of claim 1, wherein the insulation layer comprises an aerogel.

19. The insulation barrier of claim 1, wherein the encapsulation layer completely surrounds the insulation layer.

20. The insulation barrier of claim 1, wherein the encapsulation layer is composed of two laminate films heat welded together.

21. The insulation barrier of claim 1, wherein the encapsulation layer surrounds the insulation layer, and wherein the encapsulation layer is heat welded to itself to form an enclosure at least partially surrounding the insulation layer.

22. A battery module comprising:
a plurality of battery cells, and
one or more insulation barriers according to claim 1, wherein at least one insulation barrier is disposed between adjacent battery cells.

23. An electrical power system comprising one or more battery modules as described in claim 22.

24. A device or vehicle comprising an electrical power system according to claim 23.

25. The device of claim 24, wherein said device is a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool

26. The vehicle of claim 24, wherein the vehicle is an electric vehicle.

27. A method of encapsulating an insulation layer for use between battery cells in
an electrical energy storage system, the method comprising:
surrounding at least a portion of the insulation layer with a laminate film comprising an outer polymer layer, a malleable layer comprising a malleable material, and an inner polymer layer, wherein the inner polymer layer is in contact with the insulation layer and wherein the malleable layer is disposed between the outer polymer layer and the inner polymer layer; and
heat welding the laminate film to form an encapsulation layer, wherein the encapsulation layer at least partially surrounds the insulation layer.

28. The method of claim 27, wherein forming the encapsulation layer comprises:
covering at least a portion of the insulation layer with a first laminate film;
covering at least a portion of the insulation layer with a second laminate film; and
heat welding a portion of the first laminate film to the second laminate film to form the encapsulation layer.

29. The method of claim 28, wherein:
a first indentation is formed in the first laminate film, the first indentation complementary in shape and size to the insulation layer;
a second indentation is formed in the second laminate film, the second indentation complementary in shape and size to the insulation layer; and
wherein forming the encapsulation layer comprises:
placing the insulation layer in the first indentation of the first laminate film;
placing the second laminate film on the first laminate film with the second indentation substantially aligned with the first indentation; and
heat welding a portion of the first laminate film to a portion of the second laminate film.

30. The method of claim 28, wherein:
a first indentation is formed in the first laminate film, the first indentation complementary in shape and size to the insulation layer;
a second indentation is formed in the second laminate film, the second indentation complementary in shape and size to the first indentation; and
wherein forming the encapsulation layer comprises:
placing the insulation layer in the first indentation of the first laminate film;
placing the second laminate film on the first laminate film with the second indentation substantially aligned with the first indentation such that a portion of the second indention is disposed inside the first indentation; and
heat welding a portion of the first laminate film to a portion of the second laminate film.

31. The method of claim 28, wherein:
a first indentation is formed in the first laminate film, the first indentation complementary in shape and size to the insulation layer;
wherein forming the encapsulation layer comprises:
placing the insulation layer in the first indentation of the first laminate film;
placing the second laminate film on the first laminate film; and
heat welding a portion of the first laminate film to a portion of the second laminate film.

32. The method of claim 27, wherein:
a first indentation is formed in the laminate film, the first indentation complementary in shape and size to the insulation layer;
a second indentation is formed in the laminate film, the second indentation complementary in shape and size to the insulation layer; and
wherein forming the encapsulation layer comprises:
placing the insulation layer in the first indentation of the laminate film;
folding the laminate film such that the second indentation of the laminate film is substantially aligned with the first indentation; and
heat welding a portion of the laminate film to itself.

33. The method of claim 27, wherein:
a first indentation is formed in the laminate film, the first indentation complementary in shape and size to the insulation layer; and
wherein forming the encapsulation layer comprises:
placing the insulation layer in the first indentation of the laminate film;
folding the laminate film such that a portion of the laminate film substantially covers the insulation layer and a separate portion of the laminate film; and
heat welding a portion of the laminate film to itself.

34. The method of any one of claims 27, wherein the encapsulation layer completely surrounds the insulation layer.

35. The method of any one of claims 27, wherein the heat welded portions of the laminate film are folded against one or more sides of the insulation layer.
